(19) United States
(12) Patent Application Publication
(10) Pub. No.: US 2002/0175135 A1
(43) Pub. Date: Nov. 28, 2002

(54) Dust collection system for overhead traveling crane

(75) Inventors: Shinroku Nishiyama, Osaka (JP); Hiroyoshi Kimura, Shizuoka-ken (JP)

Correspondence Address: RONALD E. GREIGG, GREIGG & GREIGG P.L.L.C., 1423 POWHATAN STREET, UNIT ONE, ALEXANDRIA, VA, 22314, US

(73) Assignee: Nippon Metal Co., Ltd.

(21) Appl. No.: 09/999,192

(22) Filed: Dec. 3, 2001

(30) Foreign Application Priority Data
May 27, 1999 (JP) 11-188056

(51) Int. Cl. B66C 1/00

(52) U.S. Cl. 212/271

(57) ABSTRACT

An overhead traveling crane is movably mounted on a truck, which is installed in the inside of a foundry and the crane provides a movable body having a elevation mechanism. At least one bag-filter type dust collector is mounted on the movable body so as to directly vacuum and remove dusty and sooty which are generated due to transfer of a ladle by means of the overhead traveling crane.

### BACKGROUND OF THE INVENTION

The present invention relates to a dust collection system for an overhead traveling crane to clean the air in remarkably dusty and sooty foundries.

These days, various suggestions are made to improve working environment. In particular, improvement in working environment in foundries where soot and dust are remarkable is being seriously considered.

The conventional method to clean the air inside a foundry was adopted in which a dust collector was installed outside the foundries, from which an appropriate number of ducts leading into the foundry were installed, by which ducts dust and soot were vacuumed and removed from each part inside the foundry.

The problem of the soot and dust which are generated at various places of wide area of molding site as in a foundry could be solved by installing the ducts at appropriate positions, as the places of the generation of soot and dust are fixed, wherefore the above-mentioned dust collecting system worked efficiently in cleaning the air inside a foundry.

However, as the dust collecting system as such based on the duct arrangement has been completed, an issue of a ladle is being regarded as a problem, which so far did not attract attention as a source of generation of soot and dust in foundries.

Namely, a ladle, in which fused metal is poured from a furnace like an electric furnace, a cupola or the like, is transferred, while being hung by an overhead traveling crane, to a retainer furnace or a molding site. The ladle may sometimes be transferred from one end to the other end of the foundry. Then, soot and dust are sprinkled from the ladle all over in the foundry while the overhead traveling crane moves, as the ladle usually does not have a cover.

In particular, the ladle is in a high position being hung by an overhead traveling crane, and moves in a space in the air in the building of the foundry. However, no duct is extended to and installed in such a space, as the extension and the installation of the duct are impossible. Consequently, soot and dust sprinkled from the ladle while the ladle is being transferred by the overhead traveling crane could not efficiently be removed.

### SUMMARY OF THE INVENTION

The present invention has an object to further improve working environment by cleaning the air of the foundry in which a ladle is transferred by mean so an overhead traveling crane.

To achieve the above object, a dust collection system for an overhead traveling crane according to the present invention comprises an overhead traveling crane mounted movably on a truck installed in the inside of a foundry; said overhead traveling crane having an elevation mechanism and a movable body, and at least one bag-filter-type dust collector mounted on the movable body.

Further, in the present invention, it is preferable that the vacuum duct of the dust collector provides a dust collection hood, which is located near a hook of the overhead traveling crane.

Furthermore, in the present invention, it is preferable that an upper end of the vacuum duct of the dust collector is fixed to a fixed duct of the dust collector and its lower end is fixed to a supporter which is fixed to a bracket of the hook of the crane, and the vacuum duct is structured to be a bellows to expand and retract automatically in relation with elevating operation of the elevation mechanism.

Still further, an upper end of the dust collection hood of the vacuum duct is fixed to a supporter which is fixed to the bracket of the hook of the crane and the dust collection hood is structured to be a bellows to expand and retract to reach near a spout of the ladle which is hung on the hook of the crane.

Further, in the present invention, it is preferable to provide operation means for shifting the lower end of the dust collection hood between a position near the hook of the crane and a position near the spout of the ladle; said operation means being provided with the dust collection hood.

Furthermore, it is preferable that the operation means comprises an electric motor mounted on the upper portion of the dust collection hood and an operation wire which is fixed to a lower end of the dust collection hood on the bellows.

The foundry as define din the present invention means a foundry for cast iron, cast steel and other fused metals and it involves all of the foundries wherein a ladle id hung on an overhead traveling crane which is installed in the foundries.

According to the present invention, by providing a movable body of the overhead traveling crane with at least one dust collector, soot and dust can be directly vacuumed and removed near the pot which is hung by the overhead traveling crane, namely, near the source of generation of soot and dust.

Thus, according to this invention, dust-collecting action can be carried out efficiently while the distributing pot is transferred, though according to the conventional dust collecting system, soot and dust from the hung distribution pot transferred from one end to the other in the air within the factory could not be vacuumed and removed efficiently.

In addition, a dust collector of a bug-filter type is lightweight in comparison with the other electric dust collector, and can be controlled and maintained by regular replacement of a filter with a comparatively long intervals, wherefore there is no problem in respect of cost when such a dust collector is provided with the overhead traveling crane.

Further, according to this invention, in case a vacuum duct of the dust collector is equipped with a dust-collecting hood which is placed near the crane hook, soot and dust can be vacuumed and removed directly from an opening of the distributing pot which is a source of generation of soot and dust, and the efficiency of vacuum and removal can be improved further.

Furthermore, according to this invention, in case the dust collection hood is equipped with operation means to change the position of the lower end of the dust collection hood between a position near the hook of the crane and a position near the spout of the ladle, the bellows of the dust collection hood can be folded upwards at the time of molding so that the bellows of the dust collection hood does not disturb pouring of fused metal and field of vision for molding work.

Still further, according to this invention, in case the operation means comprises an electric motor placed above the dust collection hood and an operation wire fixed to the lower end of the dust collection hood in a state of bellows, expansion and retraction of the bellows can be electrically operated with a remote control which can be done easily.

### BRIEF DESCRIPTION OF THE DRAWINGS

The drawings show an embodiment of a dust collection system for an overhead traveling crane in which:

FIG. 1 is a front view of whole the dust collection system for an overhead traveling crane,

FIG. 2 is a plan view of whole of the system,

FIG. 3 is a side view of an essential portion of the system,

FIG. 4 is a plan view of a dust collection hood,

FIG. 5 is a side view of an essential portion of the system showing an operation,

FIG. 6 is a side view of an essential portion of the system showing another operation,

FIG. 7 is a side view of an essential portion of the system showing a further operation,

FIG. 8 is a side view of an essential portion of the system showing a further operation,

FIG. 9 is a side view of an essential portion of the system showing a further operation, and

As shown in FIG. 4, the operation means 9 comprises an electric motor 9a which is positioned on the upper portion of the dust collection hood 7 and an operation wire (not shown ), which is fixed to a lower end 7a of the dust collection hood 7 of bellows type. It is operable with remote control by means of a switch of a controller, which is connected to the electric motor 9a. An end of the operation wire (not shown) is wound on a drum of the electric motor 9a and extends to the bellows through a plurality of guide rings and another end of the wire is fixed to its lower end 7a, so that the wire is wound up and wound down with rotation of the drum so as to elevate the lower end 7a.

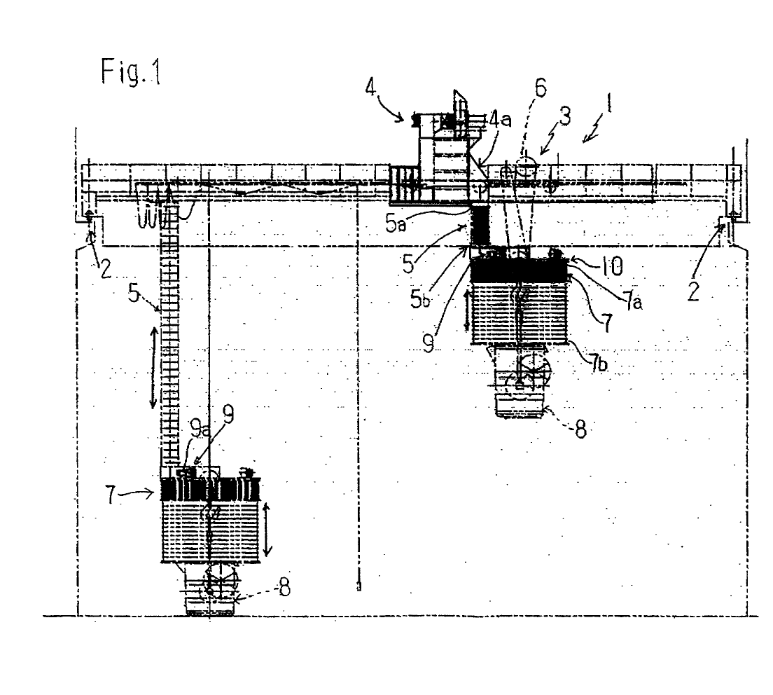

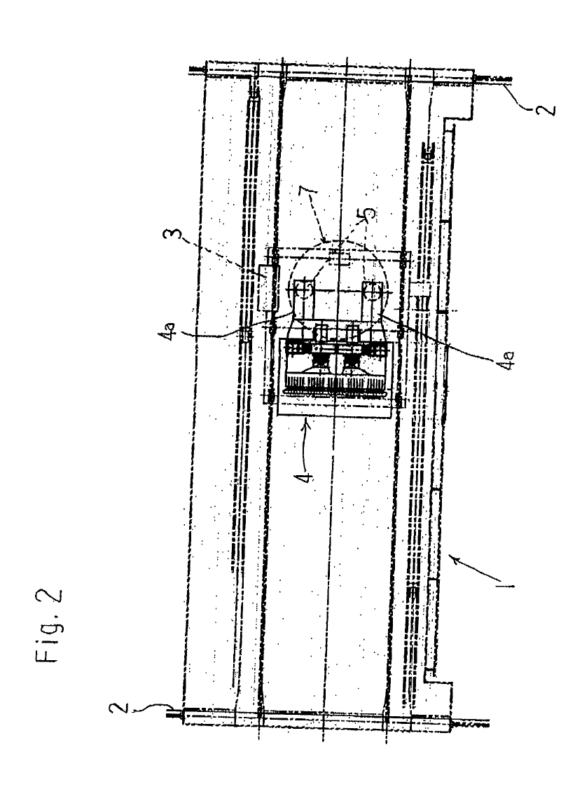

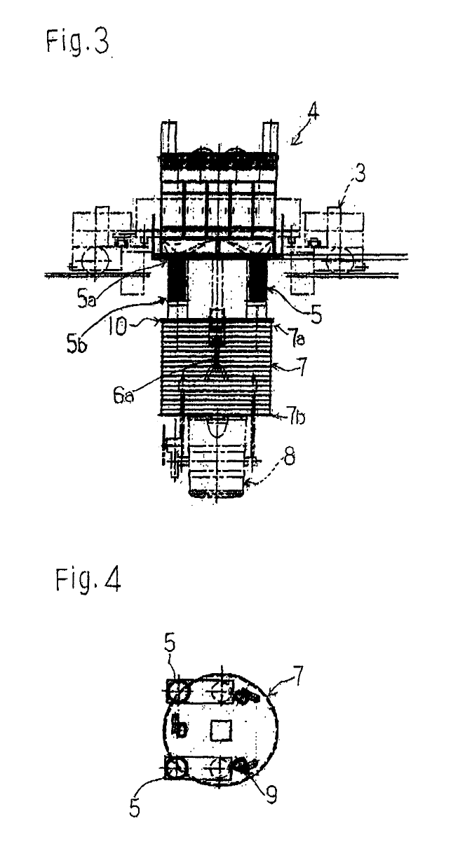

In FIG. 1, for convenience' shake of description, the ladle 8 shown on the left side shows a state that the ladle is lowered and it does not mean that the ladle 8, which is shown on the right side to be hung on the movable body 3, is provided in parallel with the ladle of the left side. Further, drawing of the dust collection hood 7 of the ladle 8 shown on right and left sides show a state of the hood folded upwards (solid line) and a state of the hood expanded downwards (phantom line).

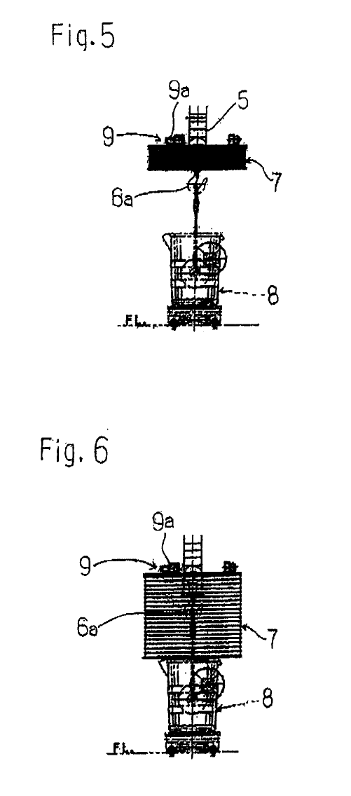

FIG. 5 shows a state that crane hook 6 of the overhead traveling crane 1 is hung after finish of pouring from a melting furnace (for instance an electric furnace) to the ladle 8. At the time, the lower end 7a of the dust collection hood 7 is folded upwards and lifted. Then, after finishing of hooking operation, as shown in FIG. 6, the lower end 7a of the dust collection hood 7 is lowered to close to the spout of the ladle 8.

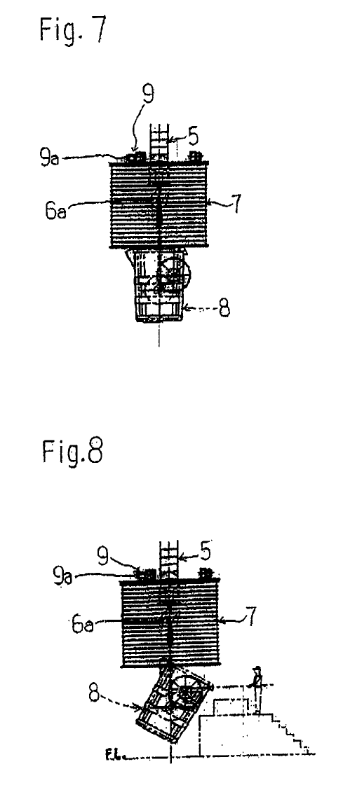

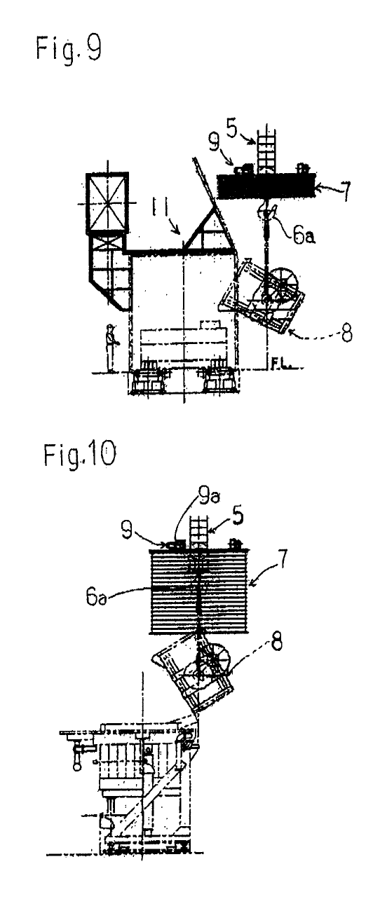

FIG. 7 shows a state that the ladle 8 is transferred by mean of the overhead traveling crane 1. Further, FIG. 8 shows a state that the ladle is inclined slightly (about 30 degrees) for removal of slag, and in such a case, it is all right that the lower end 7a of the dust collection hood 7 is being lowered.

What is claimed is:

1. A dust collection system for an overhead traveling crane comprising;
an overhead traveling crane mounted movably on a truck installed in the inside of a foundry; said overhead traveling crane having an elevation mechanism and a movable body, and
at least one bag-filter-type dust collector mounted on the movable body.

2. The dust collection system for an overhead traveling crane as claimed in claim 1, wherein a vacuum duct of the dust collector provides a dust collection hood which is located near a hook of the overhead traveling crane.

3. The dust collection system for an overhead traveling crane as claimed in claim 2, wherein an upper end of the vacuum duct of the dust collector is fixed to a fixed duct of the dust collector and its lower end is fixed to a supporter which is fixed to a bracket of the hook of the crane, and the vacuum duct is structured to be a bellows to expand and retract automatically in relation with elevating operation of the elevation mechanism.

4. The dust collection system for an overhead traveling crane as claimed in claim 3, wherein an upper end of the dust collection hood of the vacuum duct is fixed to a supporter which is fixed to the bracket of the hook of the crane and the dust collection hood is structured to be a bellows to expand and retract to reach near a spout of the ladle which is hung on the hook of the crane.

5. The dust collection system for an overhead traveling crane as claimed in claim 4, further comprising operation means for shifting the lower end of the dust collection hood between a position near the hook of the crane and a position near the spout of the ladle; said operation means being provided with the dust collection hood.

6. The dust collection system for an overhead traveling crane as claimed in claim 5, wherein the operation means comprises an electric motor mounted on the upper portion of the dust collection hood and an operation wire which is fixed to a lower end of the dust collection hood on the bellows.
